(19) United States
(12) Patent Application Publication
(10) Pub. No.: US 2014/0214376 A1
(43) Pub. Date: Jul. 31, 2014

(54) ARITHMETIC DEVICE AND ARITHMETIC METHOD

(71) Applicant: FUJITSU LIMITED, Kawasaki-shi (JP)

(72) Inventor: Masaaki Kawahito, Fuchu (JP)

(73) Assignee: FUJITSU LIMITED, Kawasaki-shi (JP)

(21) Appl. No.: 14/073,192

(22) Filed: Nov. 6, 2013

(30) Foreign Application Priority Data
Jan. 31, 2013 (JP) 2013-017894

(51) Int. Cl. G06F 17/50

(52) U.S. Cl. CPC G06F 17/5009
USPC 703/2

(57) ABSTRACT

A computer-readable recording medium stores therein a computer program. The computer program causes a computer to execute a process including: carrying out simulation computation of a simulation in which a conveyed object and a conveying device are arranged in a three-dimensional simulation space, the conveying device moving the conveyed object by pushing the conveyed object with a pushing surface of a pusher or lifting the conveyed object by supporting the conveyed object from below with a supporting surface of a lifter, and in which the conveying device conveys the conveyed object; and rotating, to carry out the simulation computation, the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.

### CROSS-REFERENCE TO RELATED APPLICATION(S)

This application is based upon and claims the benefit of priority of the prior Japanese Patent Application No. 2013-017894, filed on Jan. 31, 2013, the entire contents of which are incorporated herein by reference.

### FIELD

The embodiments discussed herein are directed to an arithmetic device and an arithmetic method.

### BACKGROUND

Conventionally known is a technology for simulating the conveyance state of a conveyed object called a workpiece. Widely known is a technology for causing a conveying device, such as a belt conveyer, a vacuum chuck, a pusher, and a lifter, in a simulation space to operate in accordance with a control program for controlling the conveying device and checking whether a workpiece is appropriately conveyed to debug the control program, for example.

There have been developed methods for conveying a workpiece in a simulation space, including a method for detecting that a conveying device comes into contact with the workpiece and simulating conveyance of the workpiece based on an operation of the conveying device that comes into contact with the workpiece. To determine, for all the elements, whether the conveying devices come into contact with the workpieces in simulating the operations of a number of workpieces and a plurality of conveying devices simultaneously, a huge amount of computation is required.

To address this, there have been developed technologies for simplifying simulation computation. Simulation computation is carried out by assuming, when a conveying device comes close to a workpiece within a predetermined distance, that the conveying device is integrated with the workpiece, for example. Conventional examples are described in Japanese Laid-open Patent Publication No. 11-33955 and Japanese Laid-open Patent Publication No. 2002-68416.

In the conventional technologies for carrying out simulation computation by assuming that a conveying device is integrated with a workpiece, however, the workpiece may possibly fail to be conveyed in a posture taken when the workpiece is actually conveyed by the conveying device. Alternatively, the workpiece may possibly be conveyed in a manner digging into the conveying device. In these cases, the workpiece is conveyed in a state different from a state of actual conveyance, whereby positional deviation of the workpiece may possibly occur. As a result, the conventional technologies for carrying out simulation computation by assuming that the conveying device is integrated with the workpiece fail to perform the simulation with high accuracy.

### SUMMARY

According to an aspect of an embodiment, a computer-readable recording medium has stored therein a computer program. The computer program causes a computer to execute a process including: carrying out simulation computation of a simulation in which a conveyed object and a conveying device are arranged in a three-dimensional simulation space, the conveying device moving the conveyed object by pushing the conveyed object with a pushing surface of a pusher or lifting the conveyed object by supporting the conveyed object from below with a supporting surface of a lifter, and in which the conveying device conveys the conveyed object; and rotating, to carry out the simulation computation, the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.

According to another aspect of an embodiment, an arithmetic device includes and executing unit and a rotating unit. The executing unit carries out simulation computation of a simulation in which a conveyed object and a conveying device are arranged in a three-dimensional simulation space. The conveying device moves the conveyed object by pushing the conveyed object with a pushing surface of a pusher or lifting the conveyed object by supporting the conveyed object from below with a supporting surface of a lifter, and the conveying device conveys the conveyed object. The rotating unit rotates the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.

According to still another aspect of an embodiment, an arithmetic method for causing a computer to execute a process including: carrying out simulation computation of a simulation in which a conveyed object and a conveying device are arranged in a three-dimensional simulation space, the conveying device moving the conveyed object by pushing the conveyed object with a pushing surface of a pusher or lifting the conveyed object by supporting the conveyed object from below with a supporting surface of a lifter, and in which the conveying device conveys the conveyed object; and rotating, to carry out the simulation computation, the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example diagram of a functional configuration of an arithmetic device according to an embodiment of the present invention;

FIG. 2A is an example view for explaining processing for integrating a conveying device and a workpiece performed by the arithmetic device;

FIG. 2B is another example view for explaining processing for integrating a conveying device and a workpiece performed by the arithmetic device;

FIG. 3 is an example view for explaining a conveying component shape table;

FIG. 4 is an example view for explaining a conveyance operation information table;

FIG. 5 is an example view for explaining a workpiece shape table;

FIG. 6 is an example view for explaining a workpiece posture table;

FIG. 7 is an example view for explaining a contact determination rectangular parallelepiped table;

FIG. 8 is an example view for explaining a contact plane table;

FIG. 9 is a view for explaining a contact determination rectangular parallelepiped of a workpiece;

FIG. 10A is a view for explaining a conveyable area of a pusher;

FIG. 10B is a view for explaining a conveyable area of a lifter;

FIG. 11 is a flowchart for explaining processing for determining integration of the workpiece and the conveying device at a certain time step; and

FIG. 12 is an example diagram for explaining a computer that executes a simulation program.

### DESCRIPTION OF EMBODIMENTS

Preferred embodiments of the present invention will be explained with reference to accompanying drawings.

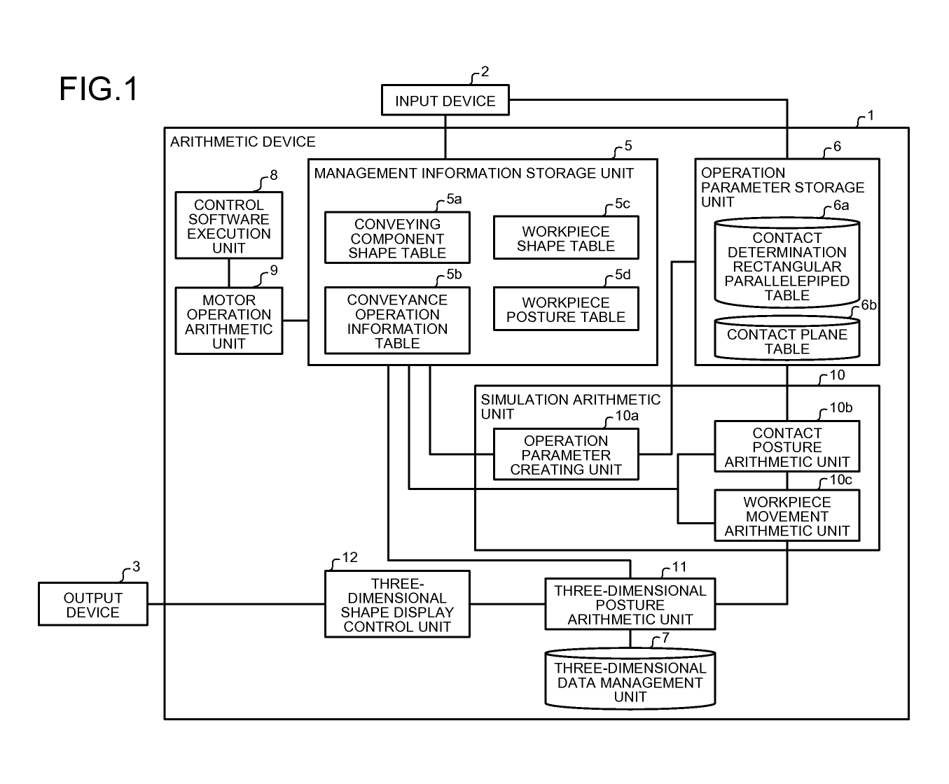

In an embodiment, an arithmetic device that simulates conveyance of a workpiece is described. FIG. 1 is an example diagram of a functional configuration of the arithmetic device according to the embodiment. As illustrated in FIG. 1, an arithmetic device 1 is connected to an input device 2 and an output device 3. The arithmetic device 1 includes a management information storage unit 5, an operation parameter storage unit 6, and a three-dimensional data management unit 7. The arithmetic device 1 further includes a control software execution unit 8, a motor operation arithmetic unit 9, a simulation arithmetic unit 10, a three-dimensional posture arithmetic unit 11, and a three-dimensional shape display control unit 12.

The management information storage unit 5 includes a conveying component shape table 5a, a conveyance operation information table 5b, a workpiece shape table 5c, and a workpiece posture table 5d. The operation parameter storage unit 6 includes a contact determination rectangular parallelepiped table 6a and a contact plane table 6b. The simulation arithmetic unit 10 includes an operation parameter creating unit 10a, a contact posture arithmetic unit 10b, and a workpiece movement arithmetic unit 10c.

The arithmetic device 1 simulates the conveyance state of a workpiece at time steps T₁, T₂, . . . , T_{N} and causes the output device 3 to output the simulation result. This enables a developer of control software that controls a conveying device to examine whether the control software appropriately controls the conveying device, for example. The arithmetic device 1 acquires, from the input device 2, information including a shape of a workpiece of which conveyance is to be simulated in a simulation space, a posture of the workpiece at an early period (time step T₁), functions of a conveying device that coveys the workpiece, and arrangement of the conveying device at an early period, for example. The arithmetic device 1 acquires three-dimensional model data of a workpiece created by computer aided design (CAD) and posture data of the workpiece at the early period, for example. Furthermore, the arithmetic device 1 acquires three-dimensional model data of a conveying device, such as a pusher, a belt conveyer, a vacuum chuck, and a lifter, created by CAD and an arrangement position of the conveying device at the early period, for example. The arithmetic device 1 uses the three-dimensional model data and other data thus acquired to perform conveyance simulation of the workpiece from the time step T₁ to the time step T_{N}. The arithmetic device 1 then causes the output device 3, which is a monitor or a printer, to output the execution result. The arithmetic device 1, for example, causes the output device 3 to output and display video in which the workpiece is conveyed by various types of conveying devices.

To simplify simulation computation, the arithmetic device 1 carries out the computation by assuming that the workpiece and the conveying device that is conveying the workpiece are integrated. Thus, the arithmetic device 1 reduces the amount of computation for the simulation. The arithmetic device 1, for example, sets a predetermined conveyable area from a contact plane serving as a surface with which each conveying device pushes the workpiece or a surface with which each conveying device lifts the workpiece in a direction pushing the workpiece forward or upward.

If the center of gravity of a contact determination rectangular parallelepiped of the workpiece is included in the conveyable area set on a certain conveying device at a certain time step, the arithmetic device 1 determines that the conveying device starts to convey the workpiece. The arithmetic device 1 carries out simulation computation by integrating the conveying device and the workpiece. In other words, the arithmetic device 1 carries out computation not for an operation of the workpiece but for an operation of the conveying device integrated with the workpiece, thereby reducing the amount of computation.

One possible manner to integrate the conveying device and the workpiece is to integrate them at a timing when it is found that the conveying device comes into contact with the workpiece and that the length of the contact portion is made equal to or smaller than a predetermined threshold as a result of a contact check between the conveying device and the workpiece, for example. If this timing is determined to be the timing for integrating the conveying device and the workpiece, however, the conveyance state of the workpiece is simulated with the conveying device digging into the workpiece. In other words, the conveyance state of the workpiece is simulated in a situation different from an actual situation in which the conveying device conveys the workpiece. As a result, the use of the timing described above as the timing for integrating the conveying device and the workpiece deteriorates accuracy of the position of the workpiece derived in the simulation. Thus, the use of the timing described above as the timing for integrating the conveying device and the workpiece prevents an examination of a control program from being made with high accuracy.

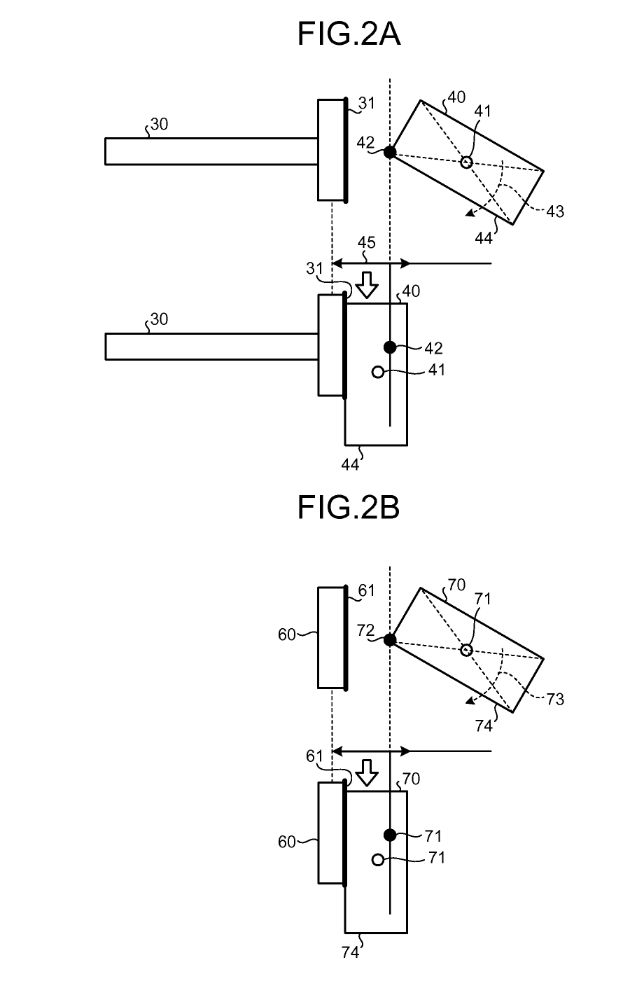

To address the above inconvenience, the arithmetic device 1 performs the following processing. FIG. 2A is an example view for explaining processing for integrating a conveying device and a workpiece performed by the arithmetic device. As illustrated in the example of FIG. 2A, if a pusher 30 moves and a center of gravity 41 of a contact determination rectangular parallelepiped of a workpiece 40 is included in a conveyable area set on the pusher 30 at a certain time step, for example, the arithmetic device 1 determines that the pusher 30 starts to convey the workpiece 40. The arithmetic device 1 then rotates the contact determination rectangular parallelepiped of the workpiece 40 so as to arrange the surface of the workpiece 40 parallel to a contact surface 31 of the pusher 30 serving as a surface that pushes the workpiece 40 forward. The arithmetic device 1 starts to rotate the contact determination rectangular parallelepiped of the workpiece 40 in a direction 43 around the center of gravity 41, for example. The direction 43 is a direction in which the contact determination rectangular parallelepiped of the workpiece 40 is rotated when a point 42 of the contact determination rectangular parallelepiped of the workpiece 40 closest to the contact surface 31 is pushed in the moving direction of the pusher 30. When the contact surface 31 and a surface 44 of the contact determination rectangular parallelepiped of the workpiece 40 are arranged in parallel, the arithmetic device 1 stops rotation of the contact determination rectangular parallelepiped. The arithmetic device 1 then moves the contact determination rectangular parallelepiped such that the surface 44 of the contact determination rectangular parallelepiped of the workpiece 40 arranged parallel to the contact surface 31 comes into contact with the contact surface 31. The arithmetic device 1 assumes that the pusher 30 and the workpiece 40 are integrated. This enables the arithmetic device 1 to simulate the conveyance state of the workpiece 40 in the same situation as the actual situation in which a pusher conveys a workpiece while preventing the pusher 30 from digging into the workpiece 40. The arithmetic device 1 can suppress deterioration in accuracy of the position of the workpiece derived in the simulation. Thus, the arithmetic device 1 can perform the examination of the control program with high accuracy.

Furthermore, the arithmetic device 1 can make the posture of the workpiece 40 taken when being conveyed by the pusher 30 the same as that of the workpiece taken when the pusher actually conveys the workpiece. This enables the arithmetic device 1 to simulate the conveyance state of the workpiece 40 in the same situation as the actual situation in which the pusher conveys the workpiece. The arithmetic device 1 can suppress deterioration in accuracy of the position of the workpiece derived in the simulation. Thus, the arithmetic device 1 can perform the examination of the control program with high accuracy.

FIG. 2B is another example view for explaining processing for integrating a conveying device and a workpiece performed by the arithmetic device. As illustrated in the example of FIG. 2B, if a lifter 60 moves and a center of gravity 71 of a contact determination rectangular parallelepiped of a workpiece 70 is included in a conveyable area set on the lifter 60 at a certain time step, for example, the arithmetic device 1 determines that the lifter 60 starts to convey the workpiece 70. The arithmetic device 1 then rotates the contact determination rectangular parallelepiped so as to arrange the surface of the contact determination rectangular parallelepiped of the workpiece 70 parallel to a contact surface 61 of the lifter 60 serving as a surface that supports and lifts the workpiece 70 from below. The arithmetic device 1 starts to rotate the contact determination rectangular parallelepiped in a direction 73 around the center of gravity 71, for example. The direction 73 is a direction in which the contact determination rectangular parallelepiped is rotated when a point 72 of the contact determination rectangular parallelepiped of the workpiece 70 closest to the contact surface 61 is pushed in the moving direction of the lifter 60. When the contact surface 61 and a surface 74 of the contact determination rectangular parallelepiped of the workpiece 70 are arranged in parallel, the arithmetic device 1 stops rotation of the contact determination rectangular parallelepiped. The arithmetic device 1 then moves the contact determination rectangular parallelepiped of the workpiece 70 such that the surface 74 of the contact determination rectangular parallelepiped of the workpiece 70 arranged parallel to the contact surface 61 comes into contact with the contact surface 61. The arithmetic device 1 assumes that the lifter 60 and the workpiece 70 are integrated. This enables the arithmetic device 1 to simulate the conveyance state of the workpiece 70 in the same situation as the actual situation in which a lifter conveys a workpiece while preventing the lifter 60 from digging into the workpiece 70. The arithmetic device 1 can suppress deterioration in accuracy of the position of the workpiece derived in the simulation. Thus, the arithmetic device 1 can perform the examination of the control program with high accuracy.

Furthermore, the arithmetic device 1 can make the posture of the workpiece 70 taken when being conveyed by the lifter 60 the same as that of the workpiece taken when the lifter actually conveys the workpiece. This enables the arithmetic device 1 to simulate the conveyance state of the workpiece 70 in the same situation as the actual situation in which the lifter conveys the workpiece. The arithmetic device 1 can suppress deterioration in accuracy of the position of the workpiece derived in the simulation. Thus, the arithmetic device 1 can perform the examination of the control program with high accuracy.

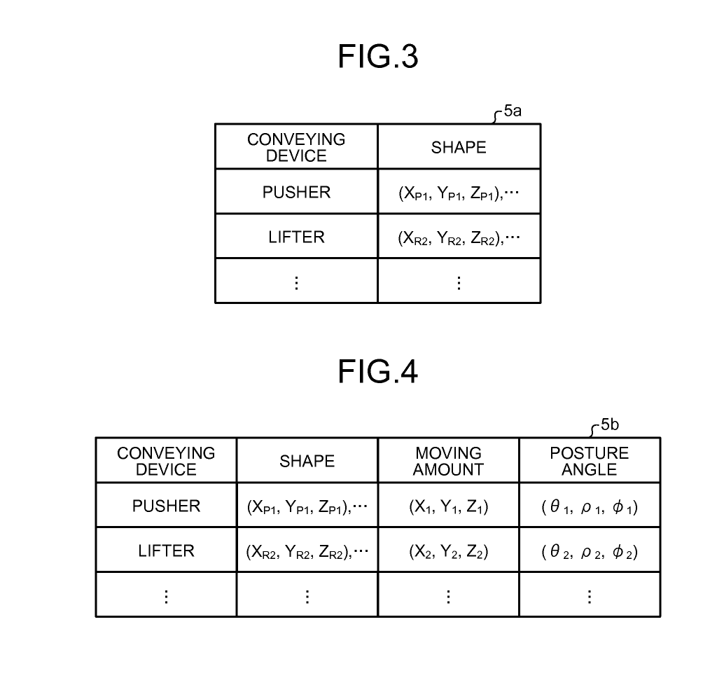

The following describes examples of the functions illustrated in FIG. 1. The conveying component shape table 5a stores therein data indicating the shape of a conveying device, such as a pusher and a lifter, received from the input device 2. FIG. 3 is an example view for explaining the conveying component shape table. In the example of FIG. 3, the conveying component shape table 5a stores therein vertex coordinates of triangular planes (polygons) forming the surface of a pusher and a lifter as the shape of the pusher and the lifter arranged in the simulation space, for example.

In the example of FIG. 3, the conveying component shape table 5a stores therein respective vertex coordinates “(X_{P1}, Y_{P1}, Z_{P1}), . . . ” of a plurality of polygons forming the surface of a certain pusher. While the simplest polygon data is stored in the example of FIG. 3, the embodiment is not limited thereto. The conveying component shape table 5a may store therein polygon data taking into account side data, for example. Furthermore, the conveying component shape table 5a may store therein lines forming a free-form surface and points forming the lines hierarchically. In other words, the conveying component shape table 5a stores therein data in an arbitrary format representing a conveying device in the simulation space.

The conveyance operation information table 5b stores therein data indicating an operation of a conveying device. FIG. 4 is an example view for explaining the conveyance operation information table. In the example of FIG. 4, the conveyance operation information table stores therein the position of the center of gravity, the moving vector indicating the moving amount and the moving direction, and the posture angle of each conveying device at the latest time step Tₖ (k=1, . . . , N) in the simulation performed by the arithmetic device 1 in a manner associated with one another.

In the example of FIG. 4, the conveyance operation information table 5b stores therein a position of the center of gravity “(X_{P1}, Y_{P1}, Z_{P1})”, a moving amount and a moving direction “(X₁, Y₁, Z₁)”, and a posture angle “(θ₁, ρ₁, φ₁)” of a certain pusher at a certain time step. The characters θ, ρ, and φ are angular information indicating how much a conveying device is rotated with respect to the axes (the X-axis, the Y-axis, and the Z-axis) in the three-dimensional space. The position of the center of gravity and the posture angle of the conveying device stored in the conveyance operation information table 5b at the time step Tₖ are updated with respective values newly derived by the three-dimensional posture arithmetic unit 11 at the time step Tₖ. The moving vector stored in the conveyance operation information table 5b at the time step Tₖ is updated with a moving vector newly derived by the motor operation arithmetic unit 9 at the time step Tₖ. The conveyance operation information table 5b stores therein the following registered contents from when the motor operation arithmetic unit 9 registers the moving vector to when the three-dimensional posture arithmetic unit 11 registers the position of the center of gravity and the posture angle of the conveying device at the time step Tₖ. The conveyance operation information table 5b stores therein the moving vector at the time step Tₖ and the position and the posture angle of the conveying device at the time step Tₖ₋₁ in a manner associated with one another. As a result, the operation parameter creating unit 10a, the contact posture arithmetic unit 10b, and the workpiece movement arithmetic unit 10c, which will be described later, refer to the following registered contents in the conveyance operation information table 5b at the time step Tₖ. The registered contents are the moving vector at the time step Tₖ and the position and the posture angle of the conveying device at the time step Tₖ₋₁.

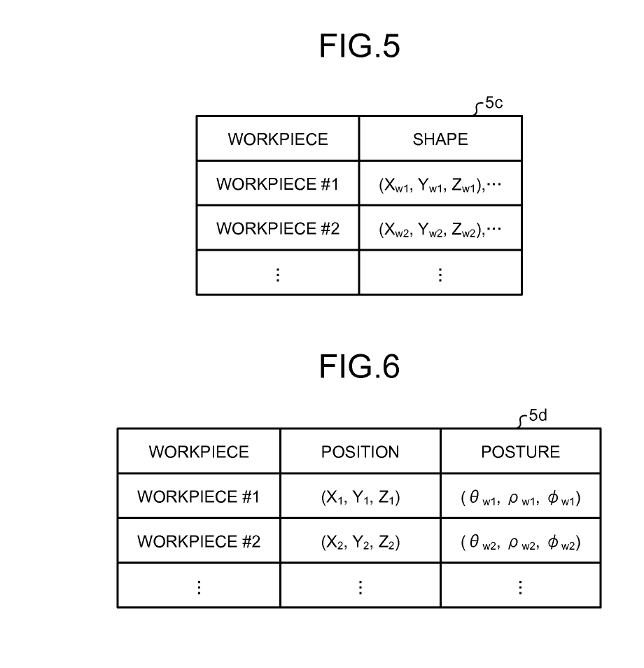

Referring back to FIG. 1, the workpiece shape table 5c stores therein the shape of a workpiece conveyed by various types of conveying devices in the simulation space. FIG. 5 is an example view for explaining the workpiece shape table. In the example of FIG. 5, the workpiece shape table 5c stores therein vertex coordinates of triangular planes (polygons) forming the surface of a workpiece #1. In the example of FIG. 5, the workpiece shape table 5c stores therein coordinate data “(X_{W1}, Y_{W1}, Z_{W1}), . . . ” of polygons forming the surface of the workpiece #1. Similarly to the conveying component shape table 5a, the workpiece shape table 5c may store therein data of a free-form surface, for example.

The workpiece posture table 5d stores therein data indicating the posture of the workpiece. FIG. 6 is an example view for explaining the workpiece posture table. In the example of FIG. 6, the workpiece posture table 5d stores therein information of the posture indicating how much each contact determination rectangular parallelepiped is rotated with respect to the axes in the three-dimensional space defining the position of the center of gravity of the contact determination rectangular parallelepiped of each workpiece and the center of gravity of the contact determination rectangular parallelepiped of each workpiece as the origin.

In the example of FIG. 6, the workpiece posture table 5d stores therein a position of the center of gravity “(X₁, Y₁, Z₁)” and a posture angle “(θ_{W1}, ρ_{W1}, φ_{W1})” of the contact determination rectangular parallelepiped of the workpiece #1. The position of the center of gravity and the posture stored in the workpiece posture table 5d at the time step Tₖ are updated with a position of the center of gravity and a posture newly derived by the three-dimensional posture arithmetic unit 11 at the time step Tₖ. The workpiece posture table 5d stores therein the following registered contents until the three-dimensional posture arithmetic unit 11 registers the position of the center of gravity and the posture angle of the contact determination rectangular parallelepiped of the workpiece at the time step Tₖ. The workpiece posture table 5d stores therein the position of the center of gravity and the posture angle of the contact determination rectangular parallelepiped of each workpiece at the time step Tₖ₋₁ in a manner associated with each other. As a result, the operation parameter creating unit 10a, the contact posture arithmetic unit 10b, and the workpiece movement arithmetic unit 10c, which will be described later, refer to the following registered contents in the workpiece posture table 5d at the time step Tₖ. The registered contents are the position of the center of gravity and the posture angle of the contact determination rectangular parallelepiped of each workpiece at the time step Tₖ₋₁.

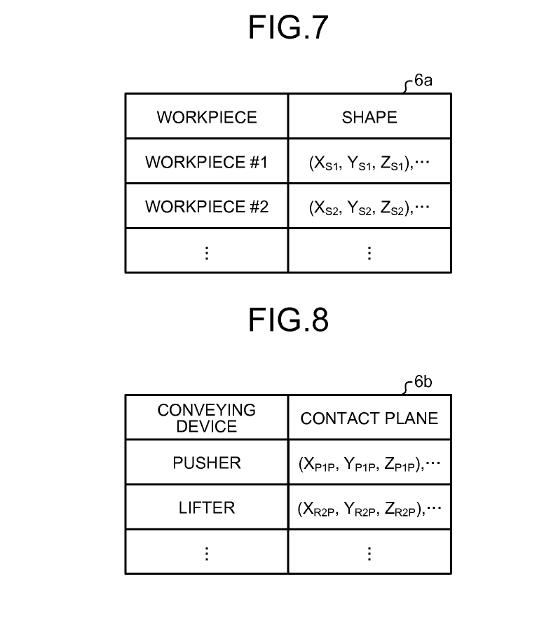

Referring back to FIG. 1, the contact determination rectangular parallelepiped table 6a stores therein polygon data forming the surface of a contact determination rectangular parallelepiped, which is a rectangular parallelepiped circumscribing a workpiece. The contact determination rectangular parallelepiped is created by the operation parameter creating unit 10a, which will be described later, at the time step Tₖ based on the position of the center of gravity and the shape of each workpiece at the time step Tₖ₋₁ prior to the time step Tₖ. FIG. 7 is an example view for explaining the contact determination rectangular parallelepiped table. In the example of FIG. 7, the contact determination rectangular parallelepiped table 6a stores therein polygon data “(X_{S1}, Y_{S1}, Z_{S1}), . . . ” forming the surface of the contact determination rectangular parallelepiped created at the time step Tₖ based on the shape of the workpiece #1 at the time step Tₖ₋₁.

The contact plane table 6b stores therein vertex coordinates of a contact plane integrated with a workpiece in conveyance of the workpiece for each type of the conveying devices. FIG. 8 is an example view for explaining the contact plane table. In the example of FIG. 8, the contact plane table 6b stores therein vertex coordinates “(X_{P1P}, Y_{P1P}, Z_{P1P}), . . . ” of a contact plane of a certain pusher. The contact plane table 6b also stores therein information, which is not illustrated in FIG. 8, indicating which side of the contact plane of the conveying device comes into contact with the workpiece. The vertex coordinates of the contact plane at each time step are created by the operation parameter creating unit 10a, which will be described later. The operation parameter creating unit 10a registers the vertex coordinates of the contact plane at each time step in the contact plane table 6b, thereby updating the contact plane table 6b.

Referring back to FIG. 1, the three-dimensional data management unit 7 stores therein various types of data used to create a simulation image. The three-dimensional data management unit 7 stores therein polygon data of the workpieces and the conveying devices and information for specifying colors used for display, for example.

The control software execution unit 8 executes control software to be debugged. The control software execution unit 8, for example, executes control software that generates a control signal for a servo motor that operates conveying devices in a factory to be simulated. The control software execution unit 8 then outputs the contents of the control signal generated by the control software to the motor operation arithmetic unit 9 at each time step from the time step T₁ to the time step T_{N} in order. The control software execution unit 8 notifies the motor operation arithmetic unit 9 of a timing at which a pulse signal indicating ON and OFF of the servo motor is turned ON, a time while the pulse signal is turned ON, and positive and negative of the pulse, for example.

In accordance with the contents of the control signal received from the control software execution unit 8, the motor operation arithmetic unit 9 calculates the number of rotation of the servo motor that operates the conveying devices at each time step, for example. The motor operation arithmetic unit 9 uses the calculation result to generate a moving vector indicating the moving amount and the moving direction of the conveying devices at each time step. The motor operation arithmetic unit 9 stores the moving vector thus generated in the conveyance operation information table 5b. Upon receiving the contents of a control signal for a servo motor that operates a pusher at a certain time step, for example, the motor operation arithmetic unit 9 calculates the direction of rotation and the number of rotation of the servo motor based on the control signal thus received. The motor operation arithmetic unit 9 derives a moving vector indicating the moving amount and the moving direction of the pusher based on the direction of rotation and the number of rotation of the servo motor thus calculated. The motor operation arithmetic unit 9 stores the moving vector thus derived in the conveyance operation information table 5b, thereby updating the conveyance operation information table 5b. The motor operation arithmetic unit 9 also calculates the amount of rotation of shafts of the conveying devices. The motor operation arithmetic unit 9 stores the amount of rotation in an item, which is not illustrated, in the conveyance operation information table 5b.

The operation parameter creating unit 10a generates an operation parameter at each time step using various types of information stored in the management information storage unit 5. The operation parameter creating unit 10a stores the operation parameter thus generated in the operation parameter storage unit 6.

The operation parameter is information used to simulate the conveyance state of a workpiece by the arithmetic device 1. The operation parameter is information used for contact determination for determining whether a workpiece and a conveying device come into contact with each other, for example. The operation parameter includes positional information of a contact determination rectangular parallelepiped circumscribing the workpiece and positional information of a contact plane on which the conveying device comes into contact with the workpiece when conveying the workpiece.

The following describes an operation of the operation parameter creating unit 10a. At the time step Tₖ, the operation parameter creating unit 10a acquires the shape of a workpiece from the workpiece shape table 5c and acquires the position of the center of gravity and the posture of the contact determination rectangular parallelepiped of the workpiece at the time step Tₖ₋₁ from the workpiece posture table 5d. Based on the shape, the position of the center of gravity, and the posture of the workpiece thus acquired, the operation parameter creating unit 10a creates polygon data forming the surface of the contact determination rectangular parallelepiped circumscribing the workpiece. The operation parameter creating unit 10a then stores the polygon data thus created in the contact determination rectangular parallelepiped table 6a.

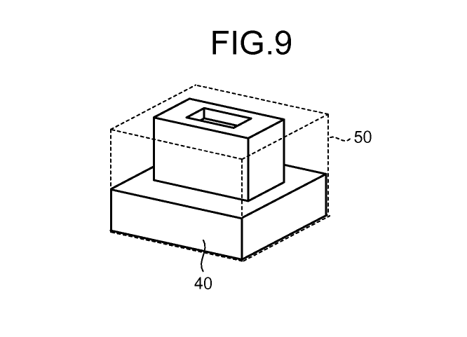

FIG. 9 is a view for explaining a contact determination rectangular parallelepiped of a workpiece. The operation parameter creating unit 10a, for example, identifies a rectangular parallelepiped 50 indicated by a dotted line in FIG. 9 as a contact determination rectangular parallelepiped of the workpiece 40 indicated by a straight line in FIG. 9. In other words, the operation parameter creating unit 10a identifies the rectangular parallelepiped 50 circumscribing the workpiece 40. The operation parameter creating unit 10a generates polygon data of polygons forming the surface of the rectangular parallelepiped 50 thus identified. The operation parameter creating unit 10a then stores the polygon data thus generated in the contact determination rectangular parallelepiped table 6a. The operation parameter creating unit 10a performs the processing for generating polygon data described above on each workpiece at each time step.

At the time step Tₖ, the operation parameter creating unit 10a also acquires the shape of a conveying device from the conveying component shape table 5a and acquires the position of the center of gravity and the posture of the conveying device at the time step Tₖ₋₁ from the conveyance operation information table 5b. Based on the shape of the conveying device and the position of the center of gravity and the posture of the conveying device at the time step Tₖ₋₁ thus acquired, the operation parameter creating unit 10a generates the following data. The operation parameter creating unit 10a creates, if the conveying device comes into contact with a workpiece, vertex coordinates of a contact plane serving as a surface that pushes the workpiece coming into contact with the conveying device forward or a surface that lifts the workpiece. The operation parameter creating unit 10a then stores the vertex coordinates of the contact plane thus created in the contact plane table 6b. The operation parameter creating unit 10a may determine a surface of the conveying device defining a vector in a direction in which the conveying device pushes the workpiece forward or a direction in which the conveying device lifts the workpiece as a normal vector to be the contact plane. As illustrated in the example of FIG. 2A, the operation parameter creating unit 10a creates the vertex coordinates of the contact surface 31 (contact plane) of the pusher 30 and stores the vertex coordinates in the contact plane table 6b, for example. The operation parameter creating unit 10a performs the processing for creating the contact plane described above on each conveying device at each time step.

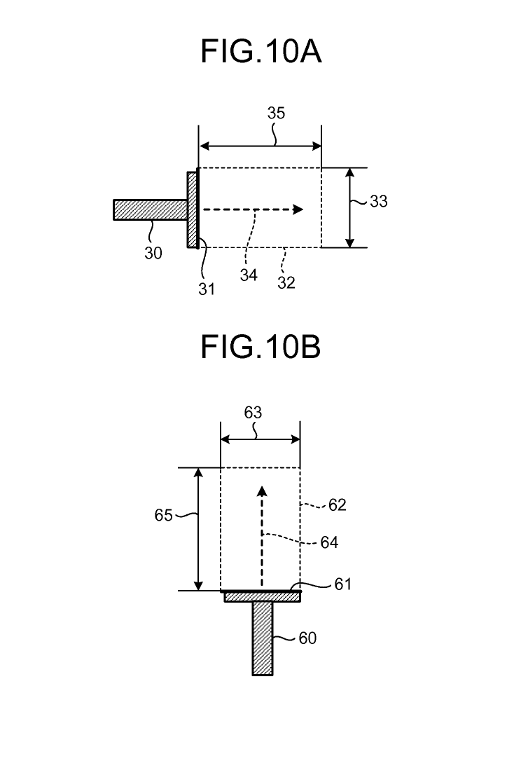

The contact posture arithmetic unit 10b uses the information stored in the operation parameter storage unit 6 to make contact determination for a workpiece. The contact posture arithmetic unit 10b, for example, acquires the shape of a contact determination rectangular parallelepiped from the contact determination rectangular parallelepiped table 6a and acquires the shape of a contact plane of a conveying device from the contact plane table 6b. The contact posture arithmetic unit 10b sets a conveyable area used to determine whether to start conveyance of the workpiece on the contact plane of the conveying device. The contact posture arithmetic unit 10b sets a predetermined conveyable area on the contact plane in the moving direction of the conveying device, for example. FIG. 10A is a view for explaining a conveyable area of a pusher. As illustrated in the example of FIG. 10A, for example, the contact posture arithmetic unit 10b creates polygon data of a conveyable area 32 used to determine whether to start conveyance of the workpiece set on the contact surface 31 of the pusher 30. As illustrated in the example of FIG. 10A, the conveyable area 32 has a width 33 equal to the width of the contact surface 31 of the pusher 30. In addition, the conveyable area 32 has a length 35 equal to the length of the contact determination rectangular parallelepiped of the workpiece to be conveyed by the pusher 30 in a moving direction 34 of the pusher 30. The contact posture arithmetic unit 10b sets the conveyable area 32 thus created on the contact surface 31 of the pusher 30.

FIG. 10B is a view for explaining a conveyable area of a lifter. As illustrated in the example of FIG. 10B, for example, the contact posture arithmetic unit 10b creates polygon data of a conveyable area 62 used to determine whether to start conveyance of the workpiece set on the contact surface 61 of the lifter 60. As illustrated in the example of FIG. 10B, the conveyable area 62 has a width 63 equal to the width of the contact surface 61 of the lifter 60. In addition, the conveyable area 62 has a length 65 equal to the length of the contact determination rectangular parallelepiped of the workpiece to be conveyed by the lifter 60 in a moving direction 64 of the lifter 60. The contact posture arithmetic unit 10b sets the conveyable area 62 thus created on the contact surface 61 of the lifter 60. The contact posture arithmetic unit 10b performs the processing for setting the conveyable area described above on each conveying device at each time step.

The contact posture arithmetic unit 10b derives the position of the center of gravity of the contact determination rectangular parallelepiped of each workpiece. The contact posture arithmetic unit 10b determines whether the position of the center of gravity thus derived is included in a conveyable area set on a conveying device that conveys the workpiece of the contact determination rectangular parallelepiped whose position of the center of gravity is derived for each workpiece. If the position of the center of gravity of a contact determination rectangular parallelepiped of a workpiece is included in a conveyable area set on a certain conveying device at the time step Tₖ, the contact posture arithmetic unit 10b can determine that the conveying device starts to convey the workpiece.

If it is determined that the center of gravity of the contact determination rectangular parallelepiped of the workpiece is included in the conveyable area at the time step Tₖ, the contact posture arithmetic unit 10b determines that the conveying device starts to convey the workpiece. As illustrated in the example of FIG. 2A, if it is determined that the center of gravity of the contact determination rectangular parallelepiped of the workpiece is included in the conveyable area at the time step Tₖ, the contact posture arithmetic unit 10b determines that the pusher 30 starts to convey the workpiece 40, for example. Subsequently, the contact posture arithmetic unit 10b calculates the amount of rotation of the contact determination rectangular parallelepiped to arrange the contact plane of the conveying device serving as a surface that pushes the workpiece forward or a surface that lifts the workpiece parallel to the surface of the contact determination rectangular parallelepiped of the workpiece.

As illustrated in the example of FIG. 2A, the contact posture arithmetic unit 10b detects the point 42 closest to the contact surface 31. The contact posture arithmetic unit 10b determines the direction 43 in which the contact determination rectangular parallelepiped is rotated when the contact determination rectangular parallelepiped of the workpiece 40 is pushed in the moving direction of the pusher 30 around the center of gravity of the contact determination rectangular parallelepiped of the workpiece 40. The contact posture arithmetic unit 10b starts to rotate the contact determination rectangular parallelepiped of the workpiece 40 in the direction 43 thus determined by the amount of rotation thus calculated. When the contact surface 31 and the surface 44 of the contact determination rectangular parallelepiped of the workpiece 40 are arranged in parallel, the workpiece movement arithmetic unit 10c stops rotation of the contact determination rectangular parallelepiped.

Referring back to FIG. 1, the workpiece movement arithmetic unit 10c calculates the distance between the contact surface and the surface of the contact determination rectangular parallelepiped of the workpiece arranged parallel to the contact surface. The workpiece movement arithmetic unit 10c then moves the workpiece in a direction in which the contact determination rectangular parallelepiped comes closer to the conveying device by the distance thus calculated such that the surface of the contact determination rectangular parallelepiped comes into contact with the contact surface. The workpiece movement arithmetic unit 10c notifies the three-dimensional posture arithmetic unit 11 that the conveying device and the workpiece are integrated. The workpiece movement arithmetic unit 10c further notifies the three-dimensional posture arithmetic unit 11 of the moving amount and the posture angle of the conveying device. The workpiece movement arithmetic unit 10c further notifies the three-dimensional posture arithmetic unit 11 of the moving amount and the posture angle of the contact determination rectangular parallelepiped of the workpiece as the moving amount and the posture angle of the workpiece.

As illustrated in the example of FIG. 2A, for example, the workpiece movement arithmetic unit 10c calculates a distance 45 between the contact surface 31 and the surface 44 of the contact determination rectangular parallelepiped of the workpiece 40 arranged parallel to the contact surface 31. The workpiece movement arithmetic unit 10c then moves the contact determination rectangular parallelepiped in a direction in which the contact determination rectangular parallelepiped comes closer to the pusher 30 by the distance 45 such that the surface 44 comes into contact with the contact surface 31. This can bring the workpiece 40 into contact with the contact surface 31 of the pusher 30 while preventing the pusher 30 from digging into the workpiece 40. Furthermore, this can make the posture of the workpiece 40 taken when the pusher 30 conveys the workpiece 40 the same as that of the workpiece taken when the pusher actually conveys the workpiece. The workpiece movement arithmetic unit 10c notifies the three-dimensional posture arithmetic unit 16 that the pusher 30 and the workpiece 40 are integrated. The workpiece movement arithmetic unit 10c further notifies the three-dimensional posture arithmetic unit 16 of the moving vector and the amount of rotation of the pusher 30 and the amount of rotation of the workpiece 40.

Referring back to FIG. 1, the three-dimensional posture arithmetic unit 11 performs the following processing on a conveying device and a workpiece integrated at the time step Tₖ based on the position of the center of gravity of the conveying device at the time step Tₖ₋₁ and the moving vector of the conveying device at the time step Tₖ. The three-dimensional posture arithmetic unit 11 derives the position of the center of gravity of a model formed of the conveying device and the workpiece integrated with each other. By contrast, the three-dimensional posture arithmetic unit 11 performs the following processing on a conveying device that is not integrated with a workpiece based on the position of the center of gravity of the conveying device at the time step Tₖ₋₁ and the moving vector of the conveying device at the time step Tₖ. The three-dimensional posture arithmetic unit 11 derives the position of the center of gravity of the conveying device at the time step Tₖ.

If the amount of rotation of the workpiece is received at the time step Tₖ, the three-dimensional posture arithmetic unit 11 performs the following processing. The three-dimensional posture arithmetic unit 11 calculates the posture angle of the workpiece at the time step Tₖ based on the amount of rotation of the workpiece at the time step Tₖ and the posture angle of the workpiece at the time step Tₖ₋₁. If the amount of rotation of the conveying device is received at the time step Tₖ, the three-dimensional posture arithmetic unit 11 performs the following processing. The three-dimensional posture arithmetic unit 11 calculates the posture angle of the conveying device at the time step Tₖ based on the amount of rotation of the conveying device at the time step Tₖ and the posture angle of the conveying device at the time step Tₖ₋₁.

The three-dimensional posture arithmetic unit 11 reads the shapes of the workpieces and the conveying devices stored in the three-dimensional data management unit 7. Subsequently, the three-dimensional posture arithmetic unit 11 sets a simulation space by arranging the shapes thus read at the positions of the center of gravity of the contact determination rectangular parallelepiped of the respective workpieces and the positions of the center of gravity of the respective conveying devices and by arranging the model formed of the conveying device and the workpiece integrated with each other at the position of the center of gravity of the model formed of the conveying device and the workpiece integrated with each other. The three-dimensional posture arithmetic unit 11 sets the simulation space such that the model formed of the conveying device and the workpiece integrated with each other, the workpieces, and the conveying devices each have the posture angle corresponding thereto. The three-dimensional posture arithmetic unit 11 notifies the three-dimensional shape display control unit 12 of the information of the simulation space thus set.

The three-dimensional posture arithmetic unit 11 stores the position of the center of gravity and the posture angle of each conveying device in the conveying component shape table 5a. The three-dimensional posture arithmetic unit 11 stores the position of the center of gravity and the posture angle of the contact determination rectangular parallelepiped of each workpiece in the workpiece posture table 5d. In terms of the conveying device and the workpiece of the model formed of the conveying device and the workpiece integrated with each other, the three-dimensional posture arithmetic unit 11 stores the position of the center of gravity of the model in the conveying component shape table 5a and the workpiece posture table 5d.

The three-dimensional shape display control unit 12 generates an image to be displayed by the output device 3 that displays the simulation space at each time step. If the information of the simulation space is received from the three-dimensional posture arithmetic unit 11, for example, the three-dimensional shape display control unit 12 generates an image of the simulation space thus received by Z-buffering and the scan-line. The three-dimensional shape display control unit 12 then transmits the image thus generated to the output device 3.

The control software execution unit 8, the motor operation arithmetic unit 9, the simulation arithmetic unit 10, the three-dimensional posture arithmetic unit 11, and the three-dimensional shape display control unit 12 are electronic circuits, for example. Examples of the electronic circuits may include an integrated circuit, such as an application specific integrated circuit (ASIC) and a field programmable gate array (FPGA), a central processing unit (CPU), and a micro processing unit (MPU).

The management information storage unit 5, the operation parameter storage unit 6, and the three-dimensional data management unit 7 are semiconductor memory devices, such as a random access memory (RAM) and a flash memory, or storage devices, such as a hard disk and an optical disk.

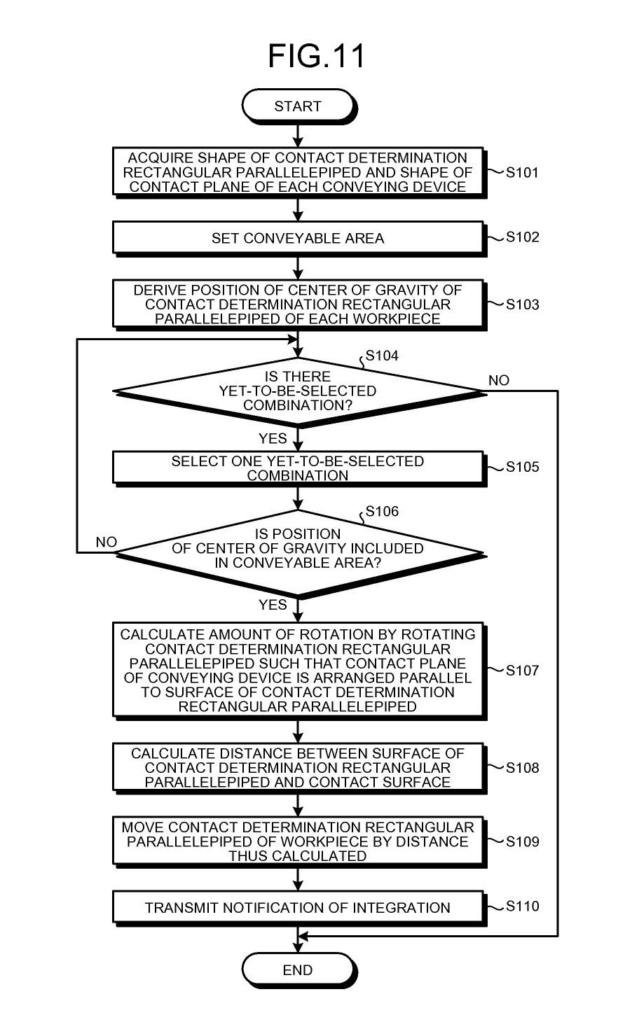

The following describes a flow of processing performed by the arithmetic device 1 with reference to FIG. 11. FIG. 11 is a flowchart for explaining processing for determining integration of a workpiece and a conveying device at a certain time step.

As illustrated in FIG. 11, the contact posture arithmetic unit 10b acquires the shape of a contact determination rectangular parallelepiped from the contact determination rectangular parallelepiped table 6a and acquires the shape of a contact plane of each conveying device from the contact plane table 6b (S101). The contact posture arithmetic unit 10b sets a conveyable area used to determine whether to start conveyance of a workpiece on the contact plane of the conveying device (S102). The contact posture arithmetic unit 10b derives the position of the center of gravity of the contact determination rectangular parallelepiped of each workpiece (S103). The contact posture arithmetic unit 10b determines whether there is a yet-to-be-selected combination among combinations of a workpiece and a conveying device that conveys the workpiece (S104). If there is no yet-to-be-selected combination (No at S104), the processing is terminated. By contrast, if there is a yet-to-be-selected combination (Yes at S104), the contact posture arithmetic unit 10b selects one yet-to-be-selected combination (S105). The contact posture arithmetic unit 10b determines whether the position of the center of gravity of the contact determination rectangular parallelepiped of the workpiece in the combination thus selected is included in the conveyable area set on the conveying device in the combination thus selected (S106).

If the contact posture arithmetic unit 10b determines that the center of gravity of the contact determination rectangular parallelepiped of the workpiece is not included in the conveyable area (No at S106), the system control is returned to S104. By contrast, if the contact posture arithmetic unit 10b determines that the center of gravity of the contact determination rectangular parallelepiped of the workpiece is included in the conveyable area (Yes at S106), the contact posture arithmetic unit 10b performs the following processing. The contact posture arithmetic unit 10b calculates the amount of rotation of the contact determination rectangular parallelepiped to arrange the contact surface of the conveying device parallel to the surface of the contact determination rectangular parallelepiped of the workpiece and rotates the contact determination rectangular parallelepiped (S107).

The workpiece movement arithmetic unit 10c calculates the distance between the contact surface and the surface of the contact determination rectangular parallelepiped of the workpiece arranged parallel to the contact surface (S108). The workpiece movement arithmetic unit 10c then moves the workpiece in a direction in which the contact determination rectangular parallelepiped comes closer to the conveying device by the distance thus calculated such that the surface of the contact determination rectangular parallelepiped of the workpiece comes into contact with the contact surface (S109). The workpiece movement arithmetic unit 10c notifies the three-dimensional posture arithmetic unit 16 that the conveying device and the workpiece are integrated. The workpiece movement arithmetic unit 10c further notifies the three-dimensional posture arithmetic unit 16 of the moving amount and the posture angle of the conveying device and the moving amount and the posture angle of the workpiece (S110). Subsequently, the processing is terminated.

As described above, the arithmetic device 1 performs the following processing. The arithmetic device 1 carries out simulation computation of a simulation in which the workpiece 40 and the pusher 30 that moves the workpiece 40 by pushing the workpiece 40 with the contact surface 31 (i.e., pushing surface) thereof are arranged in the three-dimensional simulation space and the pusher 30 conveys the workpiece 40. Furthermore, the arithmetic device 1 carries out simulation computation of a simulation in which the workpiece 70 and the lifter 60 that lifts the workpiece 70 by supporting the workpiece 70 from below with the contact surface 61 (i.e., supporting surface) thereof are arranged in the three-dimensional simulation space and the lifter 60 conveys the workpiece 70. To carry out the simulation computation, the arithmetic device 1 performs the following processing when the distance between the coordinates of the contact surface 31 of the pusher 30 or the coordinates of the contact surface 61 of the lifter 60 and the coordinates of the center of gravity of the workpiece 40 or the workpiece 70, respectively, is made equal to or smaller than a predetermined distance. The arithmetic device 1 rotates the workpiece 40 or the workpiece 70 around the position of the center of gravity.

The arithmetic device 1 can simulate the conveyance state of the workpiece 40 or 70 in the same situation as the actual situation in which a pusher or a lifter conveys a workpiece while preventing the pusher 30 or the lifter 60 from digging into the workpiece 40 or 70, respectively. The arithmetic device 1 can suppress deterioration in accuracy of the position of the workpiece derived in the simulation. Thus, the arithmetic device 1 can perform the examination of the control program with high accuracy.

The arithmetic device 1 can make the posture of the workpiece 40 taken when being conveyed by the pusher 30 the same as that of the workpiece taken when the pusher actually conveys the workpiece. Furthermore, the arithmetic device 1 can make the posture of the workpiece 70 taken when being conveyed by the lifter 60 the same as that of the workpiece taken when the lifter actually conveys the workpiece. This enables the arithmetic device 1 to simulate the conveyance state of the workpiece 40 or 70 in the same situation as the actual situation in which the pusher or the lifter conveys the workpiece. The arithmetic device 1 can suppress deterioration in accuracy of the position of the workpiece derived in the simulation. Thus, the arithmetic device 1 can perform the examination of the control program with high accuracy.

The arithmetic device 1 derives the position of the workpiece by integrating the workpiece and the lifter or the pusher. This can prevent positional deviation of the workpiece when the lifter or the pusher moves at high speed. As a result, the arithmetic device 1 can create a high-speed simulation image while maintaining the accuracy.

The arithmetic device 1 may rotate the workpiece 40 around the center of gravity when the distance between the coordinates of the contact surface 31 of the pusher 30 and the coordinates of the center of gravity of the contact determination rectangular parallelepiped of the workpiece 40 is made equal to or smaller than the distance between the center of gravity and the edge of the workpiece 40. Furthermore, the arithmetic device 1 may rotate the workpiece 70 around the center of gravity when the distance between the coordinates of the contact surface 61 of the lifter 60 and the coordinates of the center of gravity of the workpiece 70 is made equal to or smaller than the distance between the center of gravity and the edge of the workpiece 70.

When the distance between the coordinates of the contact surface 31 of the pusher 30 and the coordinates of the center of gravity of the workpiece 40 is made equal to or smaller than the predetermined distance, the arithmetic device 1 performs the following processing. The arithmetic device 1 determines the direction of rotation based on the relation between a corner of the workpiece 40 at which the workpiece 40 is determined to come into contact with the contact surface 31 and the position of the center of gravity of the workpiece 40. Furthermore, when the distance between the coordinates of the contact surface 61 of the lifter 60 and the coordinates of the center of gravity of the workpiece 70 is made equal to or smaller than the predetermined distance, the arithmetic device 1 performs the following processing. The arithmetic device 1 determines the direction of rotation based on the relation between a corner of the workpiece 70 at which the workpiece 70 is determined to come into contact with the contact surface 61 (i.e., pushing surface) and the position of the center of gravity of the workpiece 70. The arithmetic device 1 rotates the workpiece 40 or 70 in the direction of rotation thus determined around the center of gravity.

The arithmetic device 1 determines the center of rotation and the direction of rotation of the workpiece using the contact determination rectangular parallelepiped circumscribing the workpiece. This enables the arithmetic device 1 to rotate the workpiece without increasing the amount of computation.

While the embodiment of the present invention has been described in detail, it should be understood that the various changes, substitutions, and alterations could be made hereto. The following describes other embodiments.

Contact Determination Rectangular Parallelepiped

While the arithmetic device 1 defines a rectangular parallelepiped circumscribing each workpiece as the contact determination rectangular parallelepiped, the embodiment is not limited thereto. The arithmetic device 1 may receive polygon data of a contact determination rectangular parallelepiped arbitrarily set by a user from the input device 2 and store the polygon data thus received in the contact determination rectangular parallelepiped table 6a, for example.

Workpiece and Conveying Device

The workpieces and the various types of conveying devices according to the first embodiment are given just as an example, and the arithmetic device 1 can perform simulation of a workpiece having an arbitrary shape and a conveying device having an arbitrary shape. The various types of conveying devices described above are given just as an example, and the arithmetic device 1 can perform simulation of a conveying device having arbitrary functions.

Computer Program

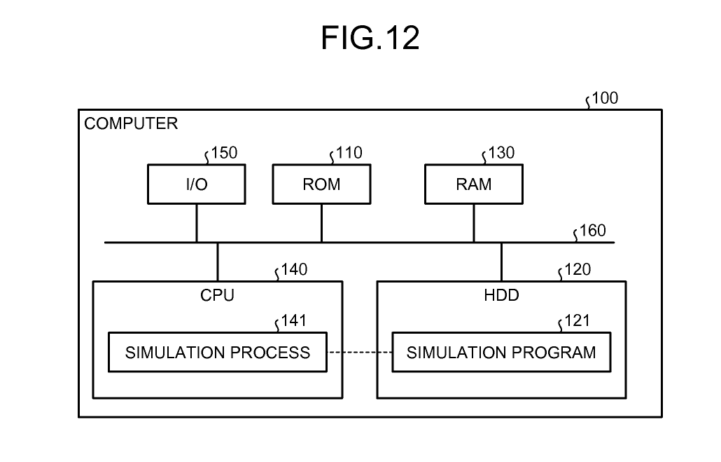

While the arithmetic device 1 according to the first embodiment uses the hardware to perform the various types of processing, the embodiment is not limited thereto. The various types of processing may be performed by a computer included in the arithmetic device 1 executing a computer program prepared in advance. The following describes an example of the computer that executes a computer program having the same functions as those of the arithmetic device 1 according to the first embodiment with reference to FIG. 12. FIG. 12 is an example diagram for explaining a computer that executes a simulation program.

A computer 100 illustrated in FIG. 12 is formed of a read-only memory (ROM) 110, a hard disk drive (HDD) 120, a RAM 130, and a CPU 140 connected to one another via a bus 160. The computer 100 illustrated in FIG. 12 includes an input-output (I/O) 150 that transmits and receives data.

The HDD 120 stores therein a simulation program 121 in advance. The CPU 140 reads and executes the simulation program 121 from the HDD 120, thereby causing the simulation program 121 to function as a simulation process 141 in the example illustrated in FIG. 12. The simulation process 141 performs the same functions as those of the control software execution unit 8, the motor operation arithmetic unit 9, the simulation arithmetic unit 10, the three-dimensional posture arithmetic unit 11, and the three-dimensional shape display control unit 12 illustrated in FIG. 1.

The simulation program 121 according to the present embodiment may be distributed over a network such as the Internet. The simulation program 121 is provided in a manner recorded in a computer-readable recording medium, such as a hard disk, a flexible disk (FD), a compact disk read-only memory (CD-ROM), a magneto optical disc (MO), and a digital versatile disk (DVD). The simulation program 121 may be executed by the computer reading the simulation program 121 from the recording medium.

An aspect of an embodiment can suppress deterioration in accuracy of simulation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a computer program causing a computer to execute a process comprising:
carrying out simulation computation of a simulation in which a conveyed object and a conveying device are arranged in a three-dimensional simulation space, the conveying device moving the conveyed object by pushing the conveyed object with a pushing surface of a pusher or lifting the conveyed object by supporting the conveyed object from below with a supporting surface of a lifter, and in which the conveying device conveys the conveyed object; and
rotating, to carry out the simulation computation, the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.

2. The computer-readable recording medium according to claim 1, wherein the rotating of the conveyed object is performed by rotating the conveyed object around center of gravity of the conveyed object when a distance between the coordinates of the pushing surface of the pusher or the coordinates of the supporting surface of the lifter and coordinates of the center of gravity is made equal to or smaller than a predetermined distance.

3. The computer-readable recording medium according to claim 1, wherein the rotating of the conveyed object is performed by rotating the conveyed object around the predetermined reference point of the conveyed object such that an edge of the conveyed object is arranged parallel to the pushing surface of the pusher or the supporting surface of the lifter when the distance between the coordinates of the pushing surface of the pusher or the coordinates of the supporting surface of the lifter and the coordinates of the predetermined reference point is made equal to or smaller than a predetermined distance.

4. The computer-readable recording medium according to claim 2, wherein the rotating of the conveyed object is performed by rotating the conveyed object around the center of gravity of the conveyed object when the distance between the coordinates of the pushing surface of the pusher or the coordinates of the supporting surface of the lifter and the coordinates of the center of gravity is made equal to or smaller than a distance between the center of gravity and an edge of the conveyed object.

5. The computer-readable recording medium according to claim 1, wherein the rotating of the conveyed object is performed by determining a direction of rotation based on a relation between a corner of the conveyed object at which the conveyed object is determined to come into contact with the pushing surface of the pusher and a position of the center of gravity of the conveyed object and rotating the conveyed object in the direction of rotation thus determined around the predetermined reference point of the conveyed object when the distance between the coordinates of the pushing surface of the pusher or the coordinates of the supporting surface of the lifter and the coordinates of the predetermined reference point is made equal to or smaller than a predetermined distance.

6. An arithmetic device comprising:
an executing unit that carries out simulation computation of a simulation in which a conveyed object and a conveying device are arranged in a three-dimensional simulation space, the conveying device moving the conveyed object by pushing the conveyed object with a pushing surface of a pusher or lifting the conveyed object by supporting the conveyed object from below with a supporting surface of a lifter, and in which the conveying device conveys the conveyed object; and
a rotating unit that rotates the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.

7. An arithmetic method for causing a computer to execute a process comprising:
carrying out simulation computation of a simulation in which a conveyed object and a conveying device are arranged in a three-dimensional simulation space, the conveying device moving the conveyed object by pushing the conveyed object with a pushing surface of a pusher or lifting the conveyed object by supporting the conveyed object from below with a supporting surface of a lifter, and in which the conveying device conveys the conveyed object; and
rotating, to carry out the simulation computation, the conveyed object around a predetermined reference point of the conveyed object when a distance between coordinates of the pushing surface of the pusher or coordinates of the supporting surface of the lifter and coordinates of the predetermined reference point is made equal to or smaller than a predetermined distance.
